(19) United States
(12) Patent Application Publication
(10) Pub. No.: US 2008/0225948 A1
(43) Pub. Date: Sep. 18, 2008

(54) Method of Data Reuse for Motion Estimation

(75) Inventors: Youn Long Lin, Hsinchu City (TW); Chao Yang Kao, Hsinchu City (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL TSING HUA UNIVERSITY, Hsinchu (TW)

(21) Appl. No.: 11/685,688

(22) Filed: Mar. 13, 2007

(51) Int. Cl. H04N 11/02

(52) U.S. Cl. 375/240.12; 375/E07.026

(57) ABSTRACT

A so-called inter-macroblock parallelism is proposed for motion estimation. First, pixel data of one of the consecutive candidate blocks in an overlapped region of search windows of current blocks in a reference frame including reference blocks corresponding to the current blocks are read and transferred to a plurality of processing element (PE) arrays in parallel. The plurality of PE arrays are used to determine the match situation of the current blocks and the reference blocks. Then, the above process is repeated for the rest of the candidate blocks in sequence. For example, if there are four current blocks CB1-CB4 and four consecutive candidate blocks, at the beginning the data of the first candidate block are read and transferred to four PE arrays in parallel, and so to the second, third and fourth candidate blocks in sequence, and the four PE arrays calculate SADs for CB1 to CB4, respectively.

### BACKGROUND OF THE INVENTION

(A) Field of the Invention

The present invention relates to a memory efficient parallel architecture for motion estimation, and more specifically to a method of data reuse for motion estimation.

(B) Description of the Related Art

H.264/AVC is the latest video coding standard of the ITU-T Video Coding Experts Group (VCEG) and ISO/IEC Moving Picture Experts Group (MPEG). Its new features include variable block sizes motion estimation with multiple reference frames, integer 4×4 discrete cosine transform, in-loop deblocking filter and context-adaptive binary arithmetic coding (CABAC). H.264/AVC can save up to 50% bit-rate compared to MPEG-4 simple profile at the same video quality level. However, a large amount of computation is required. A profiling report shows that motion estimation consumes over 90% of the total encoding time. Moreover, a large amount of pixel data is required, inducing the demand of ultra high memory and bus bandwidth. Therefore, data reuse methodology is quite important.

In traditional hardware design of motion estimation, macroblocks are processed serially. However, there is a large overlap between search windows (SW) of neighboring macroblocks, as depicted in FIG. 1 (horizontal search range: SR_{H}=+32˜−31). The pixels in search windows may be read many times in order to process different current macroblocks. For example, the overlap region is read four times in order to process current macroblocks 1-4 (CB1-CB4), as shown in FIG. 1. This causes inefficient data reuse and increases on-chip memory bandwidth. Unnecessary memory access also results in extra power consumption.

Motion estimation algorithms exploit the temporal redundancy of a video sequence. Among all the motion estimation algorithms, the full-search block-matching algorithm, as shown in FIGS. 2(a)-2(c), has been proven to find the best block match, which causes the smallest sum of absolute differences (SAD). The minimum SAD is computed as formula (1) and (2).

$$\begin{matrix}SAD ( i , j ) = {\sum }_{m = 0}^{N - 1} {\sum }_{n = 0}^{N - 1} \vert CB ( m , n ) - RB ( m + i , n + j ) \vert & ( 1 ) \\ {SAD}_{min} ( i , j ) = min ( SAD ( i , j ) ) & ( 2 )\end{matrix}$$

where CB represents current block, RB represents reference block, N is the block size, and (i, j) is the motion vector. In H.264/AVC, each picture of a video is partitioned into macroblocks of 16×16 pixels and each macroblock can be subdivided into seven kinds of variable size sub-blocks (one 16×16 sub-block, two 16×8 sub-blocks, two 8×16 sub-blocks, four 8×8 sub-blocks, eight 8×4 sub-blocks, eight 4×8 sub-blocks, or sixteen 4×4 sub-blocks). Therefore, the motion vector needs to be found, and the associated minimum SAD for each of 41 sub-blocks needs to be calculated.

As shown in FIGS. 2(a)-2(c), the overlap region 21 of 4 SWs of CB1-CB4 in a reference frame 20 includes four consecutive candidate blocks. At time=0, the pixel data of a first candidate block 23 are transferred to a 2D processing element (PE) array 22. The PE array 22 further receives the pixel data of CB1 for SAD calculation. At time=1, 2 and 3, the pixel data of a second candidate block 24, a third candidate block 25 and a fourth candidate block 26 are transferred to the 2D PE array 22, respectively. At time=4, 5, 6, 7, the process performed at time=0, 1, 2, 3 is repeated, except that the 2D PE array 22 receives the pixel data of CB2. Likewise, at time=8, 9 . . . 15, the pixel data of CB3 and CB4 are received by the 2D PE array 22 instead. Accordingly, 16 times are needed to read the pixel data of the consecutive candidate blocks 23, 24, 25 and 26.

In “On the Data Reuse and Memory Bandwidth Analysis for Full-Search Block-Matching VLSI Architecture,” IEEE Transactions on Circuits and Systems for Video Technology, Vol 12, pp. 61-72, January 2002, by Jen-Chief Tuan, Tian-Sheuan Chang, and Chein-Wei Jen, the authors provide four levels of data reuse methods: (a) Local locality within candidate block; (b) Local locality among adjacent candidate block strips; (c) Global locality within search area strip; and (d) Global locality among adjacent search area strips. In these four methods, local memory size and memory bandwidth are traded off. Larger local memory size results in lower memory bandwidth but higher hardware cost. These four methods truly decrease off-chip memory bandwidth.

In “Analysis and architecture design of an HDTV720p 30 frames/s H.264/AVC encoder,” by Tung-Chien Chen, Shao-Yi Chien, Yu-Wen Huang, Chen-Han Tsai, Ching-Yeh Chen, To-Wei Chen and Liang-Gee Chen, IEEE Transactions on Circuits and Systems for Video Technology, Volume 16, Issue 6, June 2006 Page(s): 673-688, the authors take advantage of inter-candidate parallelism, as shown in FIG. 3, and process different candidates for current block in parallel. At time=0, the pixel data of four consecutive candidate blocks are transferred to four 2D PE arrays 31 in parallel, and the four 2D PE arrays 31 receive data of CB1 for SAD calculation. Likewise, at time=1, 2, 3, the pixel data of the four consecutive candidate blocks are transferred to the four 2D PE arrays 31 in parallel, except that the four 2D PE arrays 31 receive data of CB2, CB3 and CB4, respectively. Accordingly, the times to read the pixel data of the consecutive candidate blocks can decrease to 4. This method decreases on-chip memory bandwidth but may increase off-chip memory because it consumes more reference pixels during the same clock period.

### SUMMARY OF THE INVENTION

The present invention provides a new data reuse methodology for motion estimation, e.g., used in H.264/AVC standard, so as to resolve the high demand of ultra high memory and bus bandwidth for dealing with the data reuse for motion estimation.

In accordance with a first embodiment of the present invention, a so-called inter-macroblock parallelism is proposed. First, pixel data of one of the consecutive candidate blocks in an overlapped region of search windows of current blocks in a reference frame including reference blocks corresponding to the current blocks are read and transferred to a plurality of processing element (PE) arrays in parallel. The plurality of PE arrays are used to determine the match situation of the current blocks and the reference blocks. Then, the above process is repeated for the rest of the candidate blocks in sequence. For example, if there are four current blocks CB1-CB4 and four consecutive candidate blocks, at the beginning the data of the first candidate block are read and transferred to four PE arrays in parallel, and so to the second, third and fourth candidate blocks in sequence, and the four PE arrays calculate SADs for CB1 to CB4, respectively.

In accordance with a second embodiment of the present invention, a so-called inter-macroblock and inter-candidate parallelism is proposed. Pixel data of consecutive candidate blocks in an overlapped region of search windows of current blocks in a reference frame including reference blocks corresponding to the current blocks are read and transferred to a plurality of groups each including processing element (PE) arrays in parallel. The PE arrays of each group are used to determine the match situation of the current blocks and the reference blocks. For example, if there are four current blocks CB1-CB4 and four consecutive candidate blocks, at the beginning the data of the first, second, third and fourth candidate blocks are read and transferred to four groups of PE arrays in parallel. Each group includes four PE arrays for calculating SADs for CB1 to CB4.

According to the methodology of this invention, on-chip memory bandwidth can be significantly decreased and memory access times can be saved; therefore, power consumption is reduced.

### BRIEF DESCRIPTION OF THE DRAWINGS

The objectives and advantages of the present invention will become apparent upon reading the following description and upon reference to the accompanying drawings in which:

FIG. 1 shows the search window overlap between consecutive current macroblocks in accordance with prior art;

FIGS. 2(a)-2(c) show processing steps of a traditional method without parallel processing for motion estimation;

FIG. 3 shows processing steps of a known inter-candidate parallelism method for motion estimation;

FIG. 4 shows processing steps of an inter-macroblock parallelism method in accordance with the present invention;

FIG. 5 shows processing steps of an inter-candidate and inter-macroblock parallelism method in accordance with the present invention;

FIG. 6 shows a timing diagram of the parallelism method in accordance with the present invention;

FIG. 7 shows register array and memory size analysis; and

FIG. 8 shows memory bandwidth analysis.

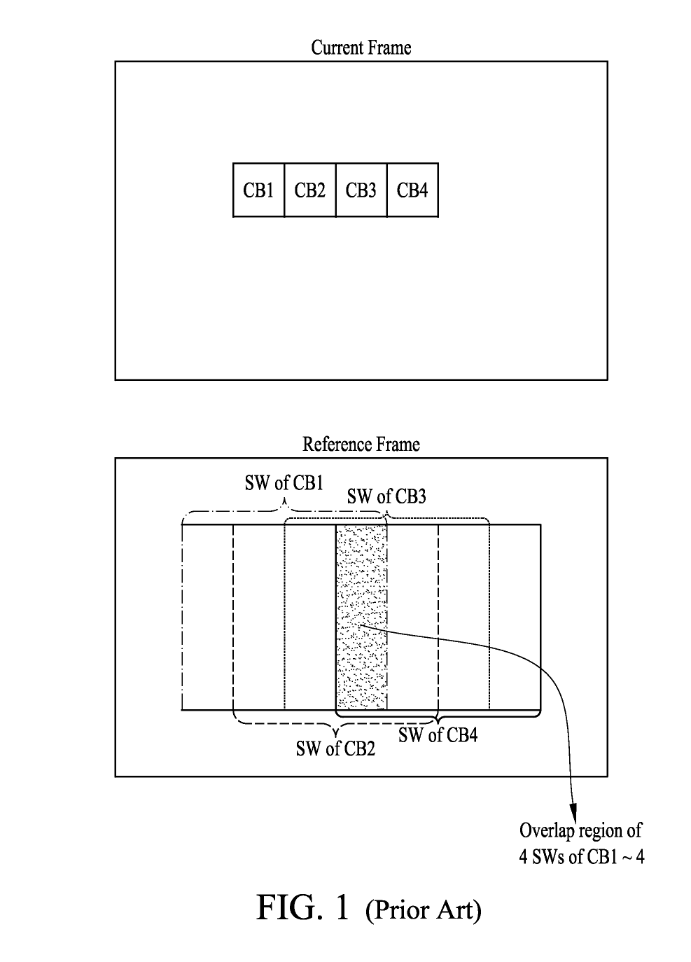

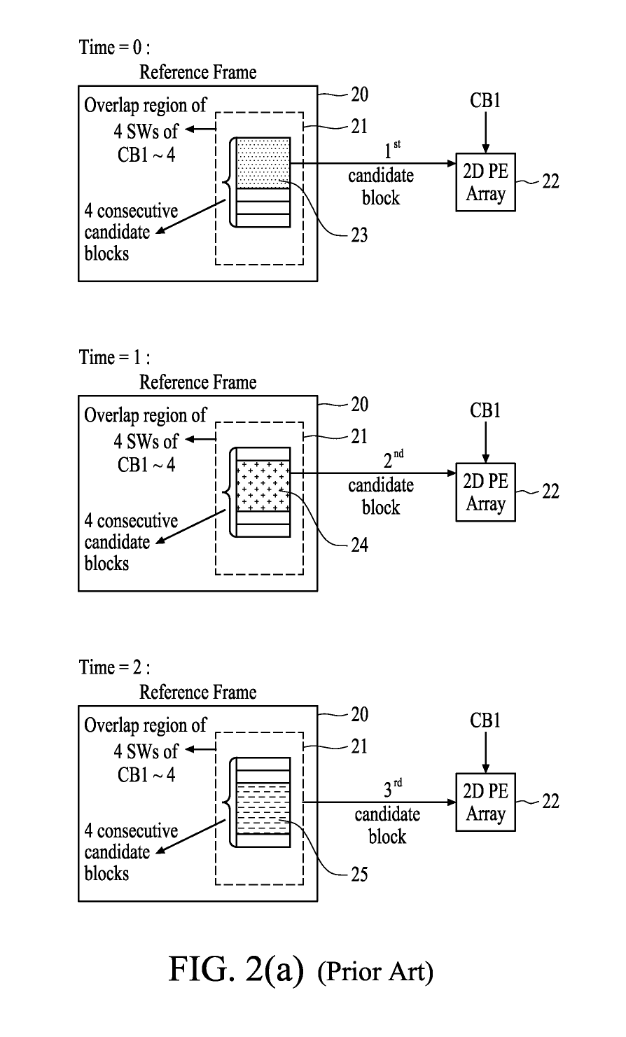

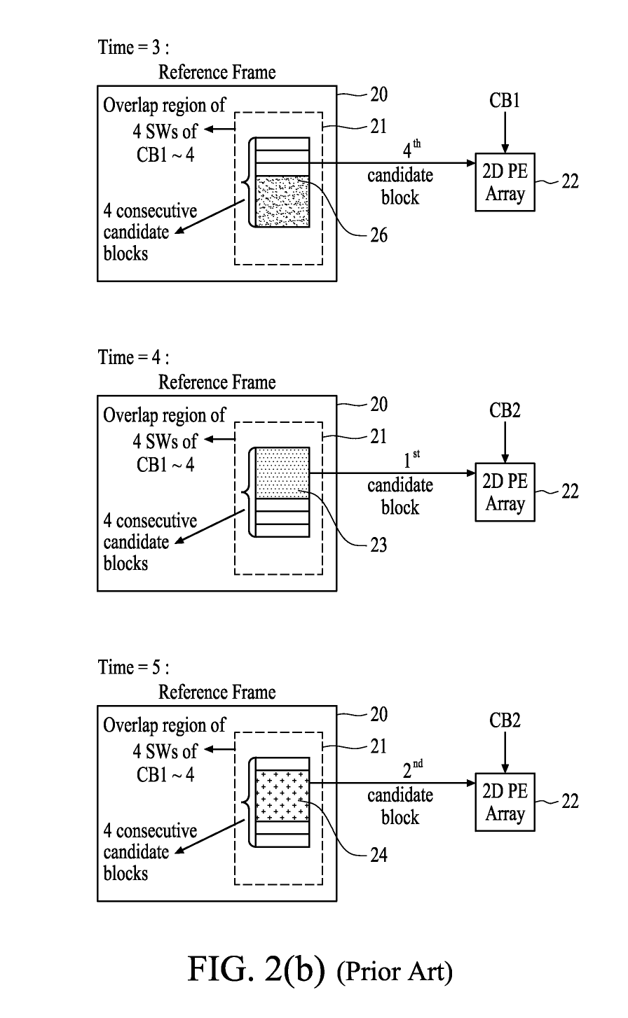

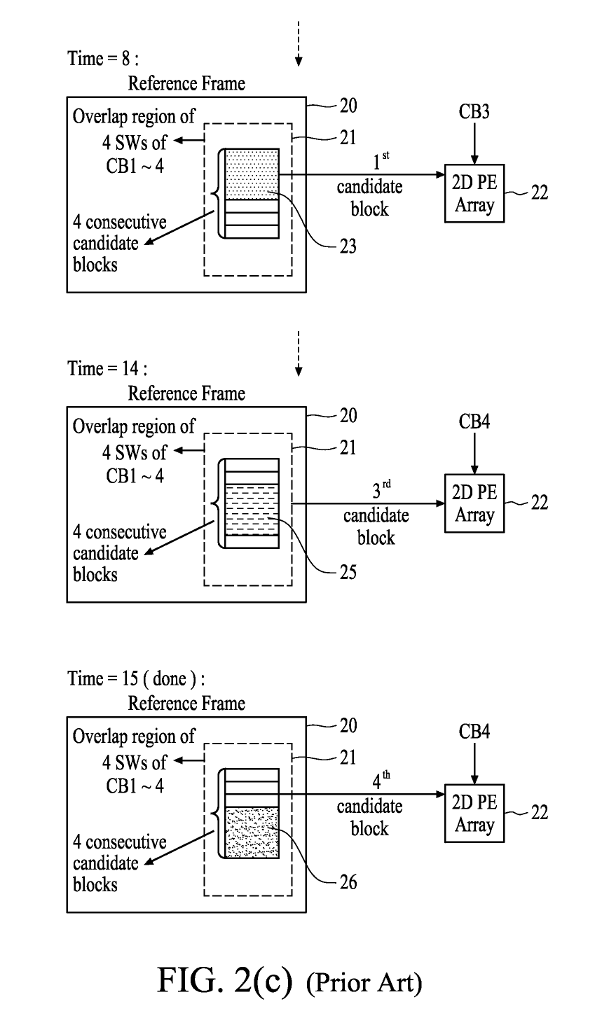

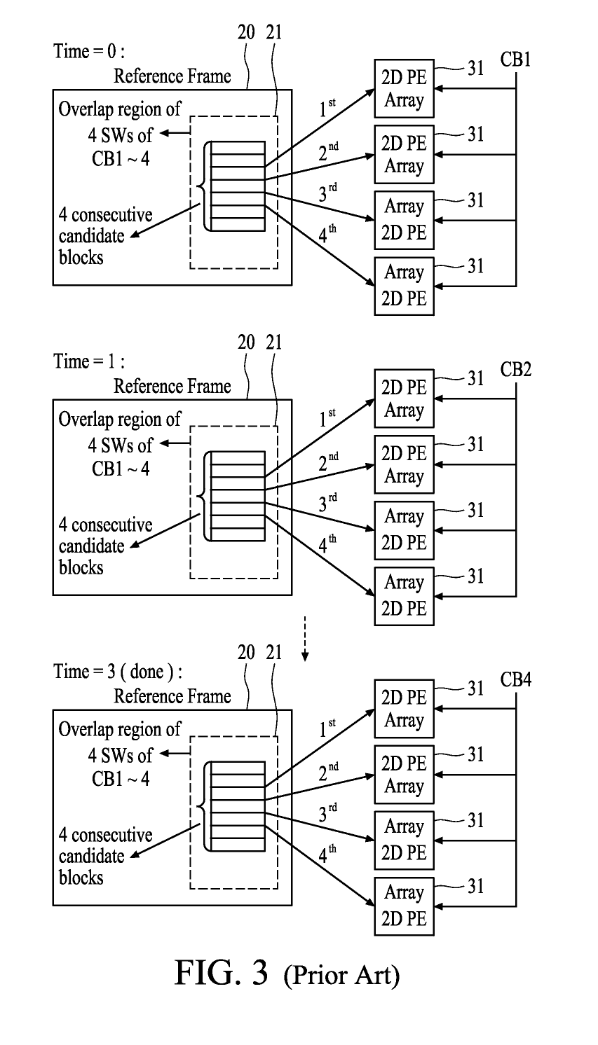

### DETAILED DESCRIPTION OF THE INVENTION

To solve those problems mentioned above, a new data reuse methodology, which takes advantage of inter-macroblock parallelism, is proposed.

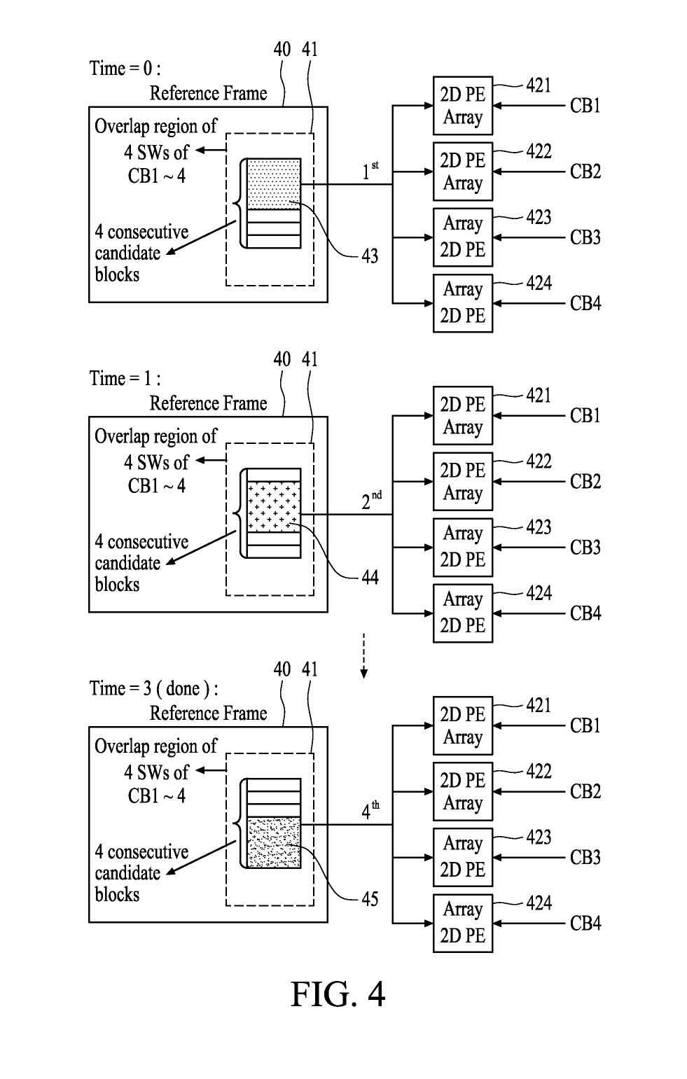

As shown in FIG. 4, a reference frame 40 includes an overlap region 41 of 4 SWs of CB1-CB4, and the overlap region 41 includes four consecutive candidate blocks 43, 44, 45 and 46. At time=0, pixel data of a first candidate block 43 are read and transferred to 2D PE arrays 421, 422, 423 and 424 in parallel. The 2D PE array 421, 422, 423 and 424 receive data from CB1, CB2, CB3 and CB4, respectively, so as to perform SAD calculations. At time=1, 2, 3, the second, third and fourth candidate blocks are read and transferred to the 2D PE arrays 421, 422, 423 and 424 in parallel. Accordingly, there are 4 times to read the pixel data of the four consecutive candidate blocks.

In summary, for increasing the data reuse rate, data of each of the candidate blocks in the overlapped region are read one at a time and in parallel transferred to four 2D processing elements (PE) arrays. Each PE array is responsible for calculating SAD for one current macroblock. This method reduces on-chip memory bandwidth N times by parallel processing of N 2D PE arrays.

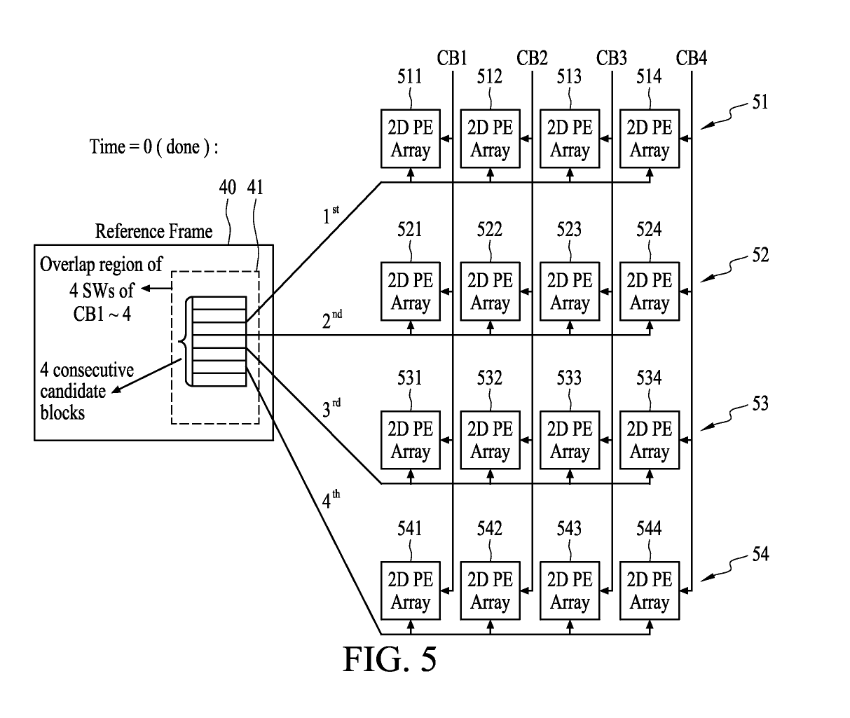

In order to further increase the data reuse ratio and reduce on-chip memory bandwidth, a combination of inter-candidate parallelism methodology and inter-macroblock parallelism methodology is proposed. FIG. 5 shows a detail architecture in which four inter-candidate parallelisms and four inter-macroblock parallelisms are adopted. Concurrently, pixel data of the first, second, third and fourth candidate blocks are read and in parallel transferred to four groups 51, 52, 53 and 54 of 2D PE arrays. The group 51 includes four 2D PE arrays 511, 512, 513 and 514; the group 52 includes four 2D PE arrays 521, 522, 523 and 524; the group 53 includes four 2D PE arrays 531, 532, 533 and 534; and the group 54 includes four 2D PE arrays 541, 542, 543 and 544. The 2D PE arrays 511, 521, 531 and 541 calculate SADs for CB1; the 2D PE arrays 512, 522, 532 and 542 calculate SADs for CB2; the 2D PE arrays 513, 523, 533 and 543 calculate SADs for CB3; and the 2D PE arrays 514, 524, 534 and 544 calculate SADs for CB4. As such, reading is completed at one time.

In summary, the degree of both parallelisms can be extended according to expected throughput. There are sixteen 2D PE arrays in total in the proposed architecture and each of them consists of 256 processing elements (PE). This sixteen-part 2D PE array is divided into four groups. Four consecutive candidate blocks are read at one time and passed parallel to four groups. Each group calculates SADs of a candidate block for four macroblocks. Therefore, the architecture can complete sixteen candidates in one clock cycle when the pipeline is full. Additionally, the search order in the architecture is column major order for realizing inter-macroblock parallelism.

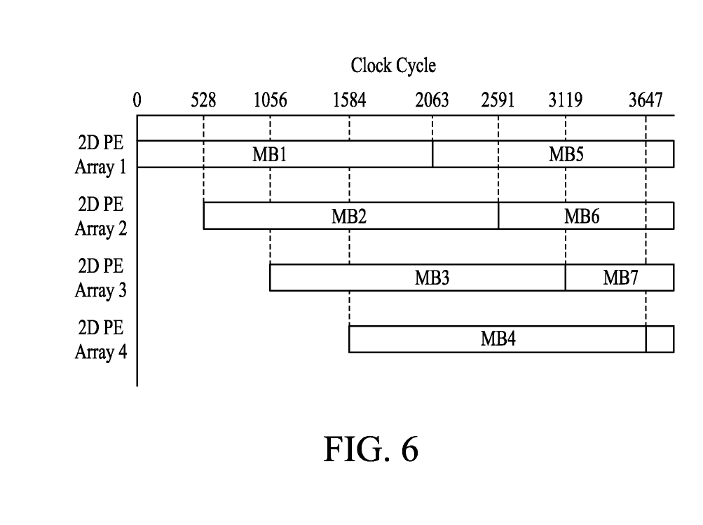

In the meantime, both the proposed inter-macroblock parallelism method and inter-candidate and inter-macroblock parallelism method can reach 100% hardware utilization, and there is no hardware and power waste. For example, the detail timing diagram of proposed inter-macroblock parallelism method is shown in FIG. 6, where the vertical search range (SR_{V}) is +16˜−15, the horizontal search range (SR_{H}) is +32˜−31 and four 2D PE arrays are used.

Because each reference pixel is read once, the proposed methodology can reduce required memory access times. Moreover, this system only saves one candidate block strip instead of one search area strip and hence reduces necessary memory size.

On-chip and off chip memory bandwidth under six different conditions are analyzed. Different sizes of memory and different reuse methodology are used in these conditions. The details of these six conditions are shown below and the results are shown in Table 1 and Table 2. In addition to memory bandwidth, hardware cost and throughput of six conditions are analyzed. Table 3 shows the detail.
1. no local memory
2. with search window strip memory
3. with search window strip memory+search window data reuse
4. with search window strip memory+local register array+search window data reuse+inter-candidate M-parallel process
5. with candidate-block strip memory+inter-MB M-parallel process
6. with candidate-block strip memory+local register array+inter-candidate M-parallel process+inter-MB M-parallel process

TABLE 1
Analysis of on-chip memory bandwidth

| Condition | On-chip memory bandwidth (Bytes/s) |
|---|---|
| 1 | 0 |
| 2 | Fᵣₐₜₑ * (F_{Width}/N) * (F_{length}/N) * SRₕ * SRᵥ * N² |
| 3 | Fᵣₐₜₑ * (F_{Width}/N) * (F_{length}/N) * SRₕ * SRᵥ * N² |
| 4 | Fᵣₐₜₑ * (F_{Width}/N) * (F_{length}/N) * ((SRₕ * SRᵥ)/M) * |
| | (N * (N + M − 1)) |
| 5 | Fᵣₐₜₑ * (F_{Width}/N) * (F_{length}/N) * ((SRₕ * SRᵥ)/M) * N² |
| 6 | Fᵣₐₜₑ * (F_{Width}/N) * (F_{length}/N) * ((SRₕ * (SRᵥ + N))/M) * N |

Fᵣₐₜₑ: frame rate
F_{Width}: frame width
F_{length}: frame length
SRₕ: horizontal search range
SRᵥ: vertical search range
N: macroblock size
M: degree of parallelism

TABLE 2
Analysis of off-chip memory bandwidth

| Condition | Off-chip memory bandwidth (Bytes/s) |
|---|---|
| 1 | Fᵣₐₜₑ * (F_{Width}/N) * (F_{length}/N) * SRₕ * SRᵥ * N² |
| 2 | Fᵣₐₜₑ * (F_{Width}/N) * (F_{length}/N) * (N + SRₕ − 1) * |
| | (N + SRᵥ − 1) |
| 3 | Fᵣₐₜₑ * (F_{Width}/N) * F_{length} * (N + SRᵥ − 1) |
| 4 | Fᵣₐₜₑ * (F_{Width}/N) * F_{length} * (N + SRᵥ − 1) |
| 5 | Fᵣₐₜₑ * (F_{Width}/N) * F_{length} * (N + SRᵥ − 1) |
| 6 | Fᵣₐₜₑ * (F_{Width}/N) * F_{length} * (N + SRᵥ − 1) |

Fᵣₐₜₑ: frame rate
F_{Width}: frame width
F_{length}: frame length
SRₕ: horizontal search range
SRᵥ: vertical search range
N: macroblock size
M: degree of parallelism

TABLE 3
Analysis of hardware cost and throughput

| | Condition | | | | | |
|---|---|---|---|---|---|---|
| | 1 | 2 | 3 | 4 | 5 | 6 |
| # of 2D | 1 | 1 | 1 | M | M | M² |
| PE array | | | | | | |
| Local | 0 | SRₕ * (N + SRᵥ − 1) | SRₕ * (N + SRᵥ − 1) | SRₕ * (N + SRᵥ − 1) | N * (N + SRᵥ − 1) | N * (N + SRᵥ − 1) |
| memory | | | | | | |
| size | | | | | | |
| Register | 0 | 0 | 0 | N * (N + M) | 0 | N * (N + M) |
| array size | | | | | | |
| Throughput | X | X | X | MX | MX | M²X |

Fᵣₐₜₑ: frame rate
F_{Width}: frame width
F_{length}: frame length
SRₕ: horizontal search range
SRᵥ: vertical search range
N: macroblock size
M: degree of parallelism

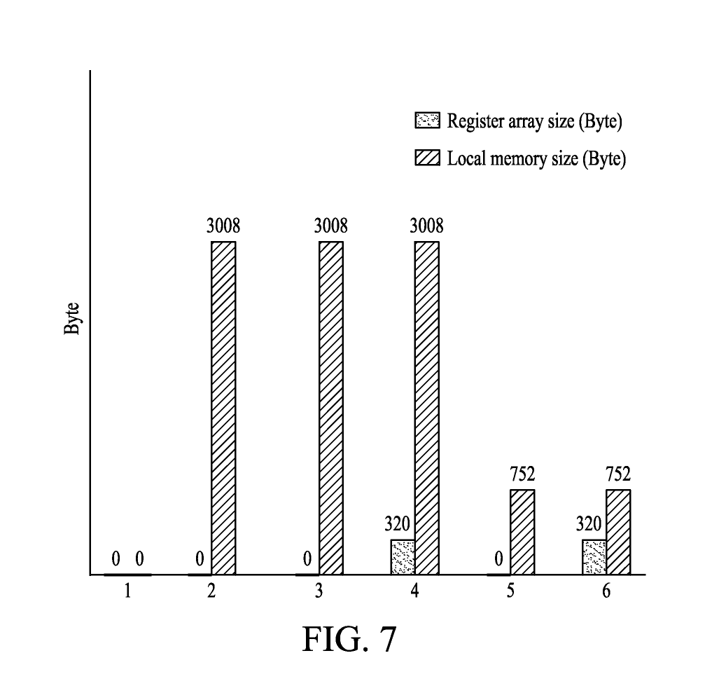

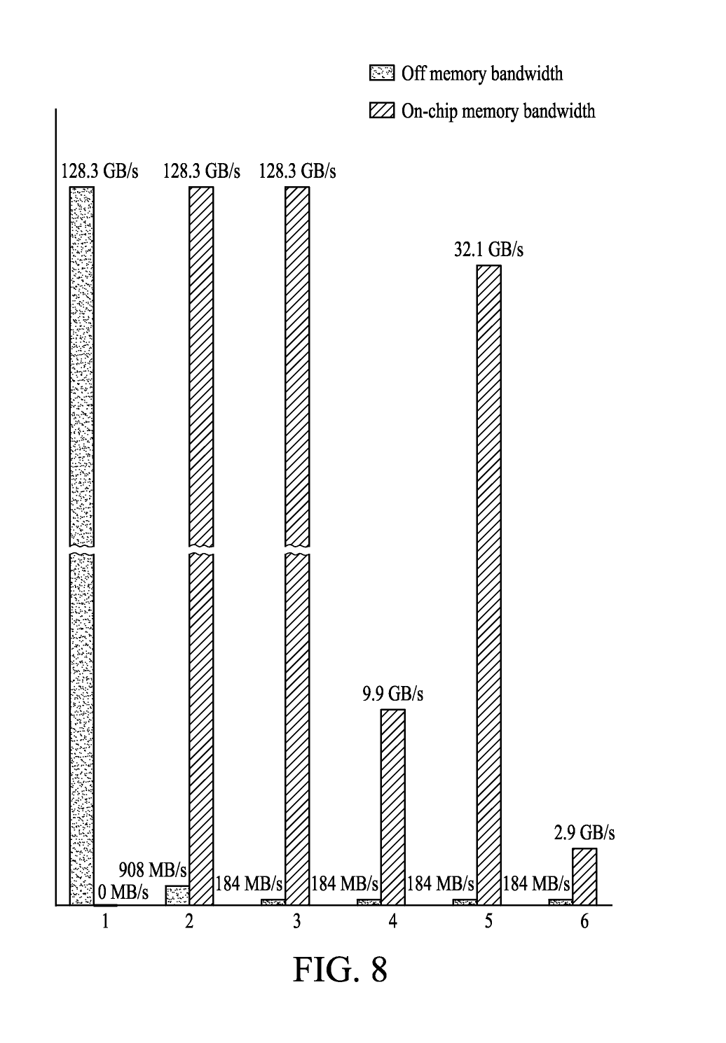

In addition, a real case is used to analyze the necessary memory size and memory bandwidth of the six conditions. The settings of the experiment are shown below and FIG. 7 and FIG. 8 show the results.

### Settings:

Frame size: 1920×1088 HDTV
Frame rate: 30 fps
Horizontal search range: [+32, −31]
Vertical search range: [+16, −15]
Number of reference frames: 1
4-parallel for inter-candidate and inter-macroblock parallelism

In this invention, a new data reuse methodology for motion estimation in H.264/AVC is proposed. Experimental results show that our methodology can reduce 97.7% of on-chip memory bandwidth (from 128.3 GBytes/s to 2.9 GBytes/s). It also saves memory access times and therefore reduces power consumption. Finally, hardware utilization of proposed architecture is still 100%.

The above-described embodiments of the present invention are intended to be illustrative only. Numerous alternative embodiments may be devised by those skilled in the art without departing from the scope of the following claims.

What is claimed is:

1. A method of data reuse for motion estimation, comprising the steps of:
(a) reading pixel data of one of consecutive candidate blocks in an overlapped region of search windows of current blocks in a reference frame including reference blocks corresponding to the current blocks;
(b) transferring the pixel data to a plurality of processing element (PE) arrays in parallel, wherein the plurality of PE arrays are used to determine the match situation of the current blocks and the reference blocks; and
(c) repeating steps (a) and (b) for the rest of the candidate blocks in sequence.

2. The method of data reuse for motion estimation of claim 1, wherein each of the PE arrays calculates the sum of the absolute difference of each of the current blocks and the corresponding reference block thereof.

3. The method of data reuse for motion estimation of claim 1, wherein the PE arrays are two-dimensional.

4. The method of data reuse for motion estimation of claim 1, which is used for video coding.

5. A method of data reuse for motion estimation, comprising the steps of:
(a) reading pixel data of consecutive candidate blocks in an overlapped region of search windows of current blocks in a reference frame including reference blocks corresponding to the current blocks; and
(b) transferring the pixel data of the consecutive candidate blocks to a plurality of groups each including processing element (PE) arrays in parallel, wherein the PE arrays of each group are used to determine the match situation of the current blocks and the reference blocks.

6. The method of data reuse for motion estimation of claim 5, wherein each of the PE arrays calculates the sum of the absolute difference of each of the current blocks and the corresponding reference block thereof.

7. The method of data reuse for motion estimation of claim 5, wherein the PE arrays are two-dimensional.

8. The method of data reuse for motion estimation of claim 5, which is used for video coding.
